(19) United States
(12) Patent Application Publication
(10) Pub. No.: US 2014/0019159 A1
(43) Pub. Date: Jan. 16, 2014

(54) METHOD, APPARATUS, AND COMPUTER PROGRAM PRODUCT FOR PATIENT CHARTING

(71) Applicants: Jaspal Singh, Boulder, CO (US); Gelene Lorentzen, Westminster, CO (US); Brandi Gimbel, Littleton, CO (US)

(72) Inventors: Jaspal Singh, Boulder, CO (US); Gelene Lorentzen, Westminster, CO (US); Brandi Gimbel, Littleton, CO (US)

(73) Assignee: MCKESSON FINANCIAL HOLDINGS, Hamilton (BM)

(21) Appl. No.: 13/547,921

(22) Filed: Jul. 12, 2012

(51) Int. Cl. G06Q 50/24

(52) U.S. Cl. 705/3

(57) ABSTRACT

A method for guided patient charting is provided. The method may include, by a patient charting apparatus, receiving a context based on patient history, visit reason, age, gender, and/or policy, and identifying recommended workflows based on the context, an access control list, and/or a rule set. The recommended workflows may then be visually distinguished from that of the non-recommended workflows. Recommendations at the field-level may also be provided. Administration of workflow settings is provided. Corresponding apparatuses and computer program products are also provided.

### TECHNOLOGICAL FIELD

Embodiments of the present invention relate generally to computer technology and, more particularly, relate to methods, apparatuses, and computer program products for patient charting.

### BACKGROUND

The widespread use of modern computing technology has led to an increasing demand for information to be captured and made available via computer-based applications. The medical services industry in particular relies on systems to store and maintain patient data in a centralized location made accessible to various authorized users.

Nurses, doctors, and other medical professionals may enter and access patient information in computer based applications. Decreasing the dependency on paper charts and files may allow authorized users to access patient information from different locations and may minimize the risk of losing patient records and/or creating data discrepancies, while ensuring necessary data is captured. The amount and complexity of patient information recorded during an office visit may make it difficult for a practitioner to distinguish what information is needed in certain scenarios, and what information may not need to be charted.

### BRIEF SUMMARY OF SOME EXAMPLE EMBODIMENTS

Methods, apparatuses, and computer program products are therefore provided for guided patient charting. Embodiments provided herein may provide several advantages for medical practitioners including efficient entry of patient charting data, and/or a more gradual learning curve for new employees. Some embodiments may also help providers ensure they are in compliance with policies by guiding them through the capture of patient information.

In some embodiments, a method is provided for receiving a context associated with a session, identifying recommended workflows based on the context, and causing display of the recommended workflows to differ from that of a non-recommended workflow. The recommended workflows may be displayed and the non-recommended workflows may be hidden from view. The context may be based on at least one of patient history, a patient visit reason, age, gender or policy. Recommended workflows may be updated dynamically throughout the patient charting session.

According to some embodiments, the recommended workflow may be further based on an access control list and/or rules. The method may further cause display of a recommended field to differ from that of a non-recommended field. Administration of a workflow's status indicator, access control list, and rules is provided.

In some embodiments, an apparatus is provided that includes processing circuitry configured to cause the apparatus to receive at least one context associated with a session, identify at least one recommended workflow based on the context, and cause display of the recommended workflows to differ from that of a non-recommended workflow. In some embodiments, the recommended workflows may be displayed, and the non-recommended workflows will not be displayed. The context may be based on at least one of patient history, patient visit reason, age, gender, or policy.

In some embodiments, the apparatus may additionally dynamically update throughout the patient charting session. The recommended workflows may be based on an access control list and/or rules.

In some embodiments, the apparatus may cause display of a recommended field to differ from that of a non-recommended field. The apparatus may be further configured to provide administration of a workflow's status indicator, access control list, and/or rules.

In some embodiments, a computer program product is provided that includes at least one non-transitory computer-readable medium having computer-readable program instructions stored therein with the computer-readable program instructions including instructions, which when performed by an apparatus, are configured to cause the apparatus to receive at least one context associated with a session, identify recommended workflows based on the context, and cause display of the recommended workflow to differ from that of a non-recommended workflow. According to some embodiments, recommended workflows may be displayed while non-recommended workflows are hidden. The context may be based on patient history, patient visit reason, age, gender, and/or policy. According to some embodiments, the instructions may be further configured to cause the apparatus to dynamically update the recommended workflows during the patient charting session. In some embodiments, the recommended workflows may be further based on an access control list and/or rules.

In some embodiments, the instructions are further configured to cause the apparatus to at least cause display of a recommended patient charting field to differ from that of a non-recommended patient charting field. Computer program instructions may provide for administration of a workflow's status indicator, access control list, and/or rules.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for patient charting according to some example embodiments;

FIG. 2 illustrates a block diagram of a patient charting apparatus in accordance with some example embodiments;

FIG. 3 illustrates a flowchart for recommending patient charting workflows according to some example embodiments;

FIG. 4 illustrates a flowchart for administering patient charting according to some example embodiments;

FIG. 5A and FIG. 5B are visual representations of context-workflow mappings according to some example embodiments; and

FIG. 6 is a display illustrating patient charting workflows according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described herein to receive data from another computing device, it will be appreciated that the data may be received directly from the another computing device and/or may be received indirectly via one or more intermediary computing devices, such as, for example, one or more servers, relays, routers, network access points, and/or the like. Similarly, where a computing device is described herein to send data to another computing device, it will be appreciated that the data may be sent directly to the another computing device or may be sent to the another computing device via one or more interlinking computing devices, such as, for example, one or more servers, relays, routers, network access points, and/or the like.

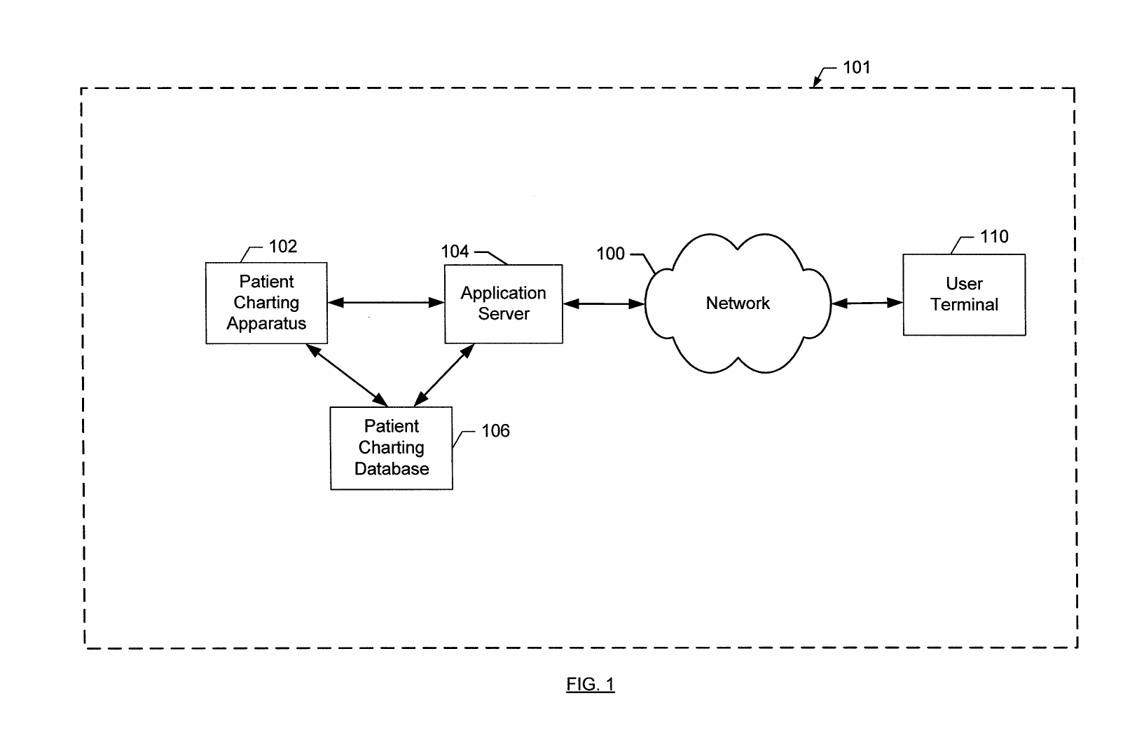

FIG. 1 illustrates a system 101 for patient charting according to some example embodiments. In this regard, a system such as system 101 may be used by a healthcare provider to chart patient information regarding a patient's appointment at a healthcare facility. More specifically, patient charting may include any capture or modification of data relating to a patient, such as data associated with an electronic health record (EHR), for example. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for managing patient charting, numerous other configurations may also be used to implement embodiments of the present invention.

The system 101 may include any number of application server(s) 104 that may support and/or provide application code written in a variety of languages, providing various applications that may be used by a healthcare provider in a healthcare setting to enter and/or maintain patient charting data in a patient charting database 106. More specifically, the applications may comprise various workflows for patient charting. A workflow may provide data capture and/or maintenance for any number of data fields that may be related to each other or otherwise logically grouped together, and/or content relating to the workflow. In some embodiments, a workflow may dictate to a user a set of user steps or user actions to be performed. For example, a workflow for vital signs may include indication to chart blood pressure, body temperature, heart rate, and/or respiratory rate, for example. The workflow may also provide content or links to information providing more detail regarding the vital signs. A workflow may be associated with a display or group of displays, or otherwise be visibly distinguished from other workflows for ease in user navigation.

In some embodiments, patient data records may be stored on patient charting database 106, which may be implemented as any number of databases and may be accessible to application server(s) 104 via direct connection and/or over a network. In some embodiments, patient charting database 106 may be implemented on the same apparatus as an application server 104.

In some embodiments, system 101 may include patient charting apparatus 102 that may be configured to provide patient charting services, such as recommending workflows and/or providing administration capabilities, to one or more application servers 104. Patient charting apparatus 102 may be directly coupled to the application server(s) 104, or accessed over a network. For example, in embodiments in which a patient charting apparatus 102 is disposed remotely from the application server(s) 104, patient charting services may be provided to the application server(s) 104 via a network 100, by a variety of connections. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet.

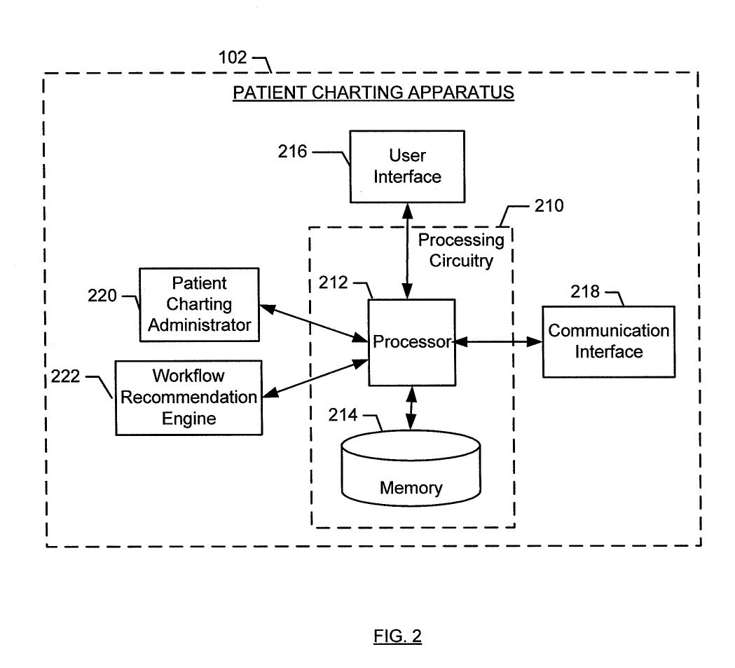

In some example embodiments, patient charting apparatus 102 may be embodied as or comprise one or more computing devices, such as, by way of non-limiting example, a server, configured to access network 100 and/or application server(s) 104. In some example embodiments, patient charting apparatus 102 may be implemented as a distributed system or a cloud based entity that may be implemented within network 100. In this regard, patient charting apparatus 102 may comprise one or more servers, a server cluster, one or more network nodes, a cloud computing infrastructure, some combination thereof, or the like. Additionally or alternatively, patient charting apparatus 102 may be implemented as a web service. In some embodiments, patient charting apparatus 102 may be implemented in the same apparatus as one or more application servers 104. An example embodiment of patient charting apparatus 102 is illustrated in FIG. 2 and is described in further detail hereinafter.

System 101 may include any number of user terminal(s) 110. User terminal(s) 110 may be embodied as a laptop computer, tablet computer, mobile phone, desktop computer, workstation, or other like computing device. A user terminal 110 may be remote from the application server(s) 104, patient charting apparatus 102, and/or patient charting database 106, in which case the user terminal 110 may communicate with any of the respective apparatuses via network 100. Additionally or alternatively, the user terminal 110 may be implemented on or otherwise co-located with application server(s) 104, patient charting apparatus 102, and/or patient charting database 106. A user of user terminal(s) 110, such as a medical practitioner and/or patient, may access workflows provided by application server(s) 104 via network 100 to access, capture, and/or maintain patient charting information to be stored in patient charting database 106.

FIG. 2 illustrates a patient charting apparatus 102 in further detail, in accordance with some example embodiments. However, it should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

The patient charting apparatus 102 may include processing circuitry 210. Processing circuitry 210 may be configured to perform actions in accordance with one or more example embodiments disclosed herein. In this regard, the processing circuitry 210 may be configured to perform and/or control performance of one or more functionalities of the patient charting apparatus 102 in accordance with various example embodiments. The processing circuitry 210 may be configured to perform data processing, application execution, and/or other processing and management services according to one or more example embodiments. In some embodiments, the patient charting apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with, include or otherwise control a user interface 216, a patient charting administrator 220, workflow recommendation engine 222, and/or a communication interface 218. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of patient charting apparatus 102 as described herein. The plurality of processors may be embodied on a single computing device or distributed across a plurality of computing devices collectively configured to function as the patient charting apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the patient charting apparatus 102. The memory 214 may be configured to store information, data, applications, instructions and/or the like for enabling the patient charting apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, communication interface 218, patient charting administrator 220, or workflow recommendation engine 222 for passing information among components of patient charting apparatus 102.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of patient charting operations and/or the like. In some example embodiments in which the patient charting apparatus 102 is embodied as a server, cloud computing system, or the like, aspects of user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate patient charting operations in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable patient charting apparatus 102 to communicate with application server(s) 104 and/or patient charting database 106. Accordingly, the communication interface 218 may, for example, include supporting hardware and/or software for enabling communications via cable, digital subscriber line (DSL), universal serial bus (USB), Ethernet, or other methods.

In some example embodiments, the processor 212 (or the processing circuitry 210) may be embodied as, include, or otherwise control a patient charting administrator 220. As such, the patient charting administrator 220 may be embodied as various means, such as circuitry, hardware, a computer program product comprising computer readable program instructions stored on a computer readable medium (for example, the memory 214) and executed by a processing device (for example, the processor 212), or some combination thereof. Patient charting administrator 220 may be capable of communication with one or more of the processor 212, memory 214, user interface 216, and communication interface 218 to access, receive, and/or send data as may be needed to perform one or more of the functionalities of the patient charting administrator 220 as described herein. In some example embodiments, patient charting administrator 220 may be implemented as a web service, such as, for example, those created using Apache Axis platform, or a server-side software application. It will be appreciated that implementing patient charting administrator 220 as a web service is cited as a non-limiting example, and should not be construed to narrow the scope or spirit of the disclosure in any way.

Patient charting apparatus 102 may include, in some embodiments, a workflow recommendation engine 222 configured to perform functionalities as described herein. Processor 212 (or the processing circuitry 210) may be embodied as, include, or otherwise control a workflow recommendation engine 222. As such, the workflow recommendation engine 222 may be embodied as various means, such as circuitry, hardware, a computer program product comprising computer readable program instructions stored on a computer readable medium (for example, the memory 214) and executed by a processing device (for example, the processor 212), or some combination thereof. Workflow recommendation engine 222 may be capable of communication with one or more of the processor 212, memory 214, user interface 216, communication interface 218, and patient charting administrator 220 to access, receive, and/or send data as may be needed to perform one or more of the functionalities of the workflow recommendation engine 222 as described herein. Additionally, or alternatively, workflow recommendation engine 222 may be implemented on patient charting administrator 220. In some example embodiments in which the patient charting apparatus 102 is embodied as a server cluster, cloud computing system, or the like, patient charting administrator 220 and workflow recommendation engine 222 may be implemented on different apparatuses. Like patient charting administrator 220, workflow recommendation engine 222 may be implemented as a web service, however, it will again be appreciated that workflow recommendation engine 222 may be implemented using a variety of architectures, and that a web service implementation is provided merely as an example.

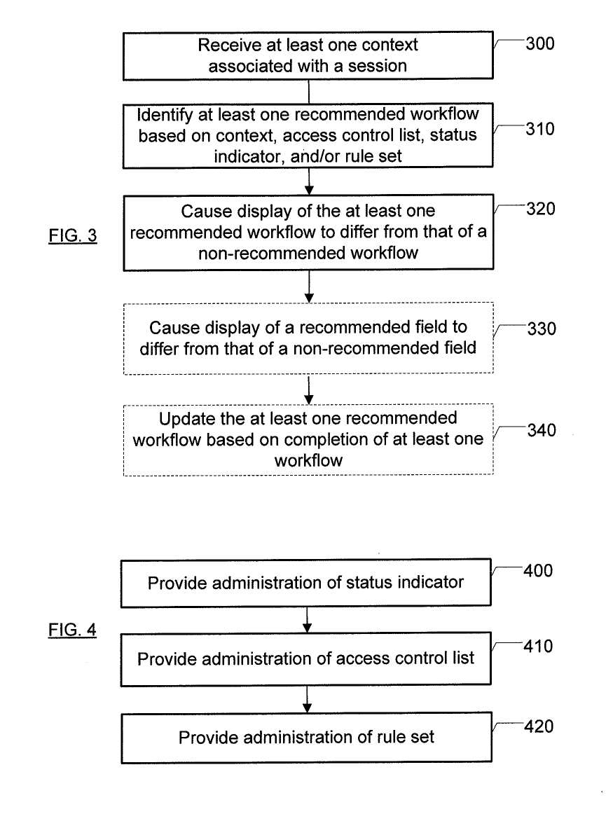

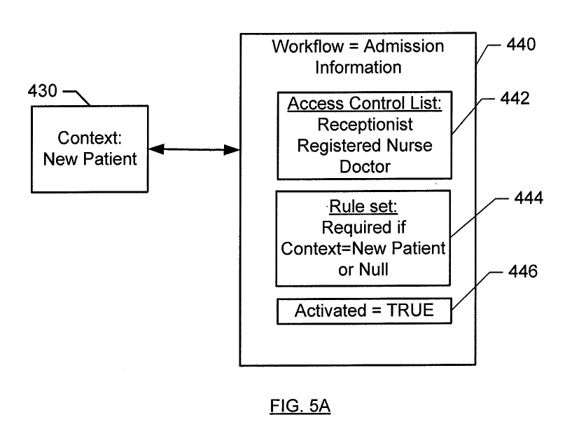

FIGS. 3 and 4 are flowcharts of operations according to some embodiments. Operations illustrated in FIGS. 3 and 4 may be performed by a patient charting apparatus 102 and, more particularly, may be performed by, with the assistance of, and/or under the control of one or more of the processing circuitry 210, processor 212, memory 214, user interface 216, communication interface 218, patient charting administrator 220, and workflow recommendation engine 222.

The operations of FIG. 3 may be initiated, for example, at the start of an appointment with a patient. For example, when a new patient arrives for an initial appointment, a user such as a doctor and/or nurse may launch an application to chart patient data in a patient charting session. A patient charting session may include any use of an application to assist a user in completing workflows. Some or all information captured during a patient charting session may be associated with an EHR. In some embodiments, the data charted by a physician, for example, may vary depending on the data already collected. In other words, the workflows accessed during the patient charting session may be dynamic based on information charted in other workflows of the same session. Some workflows may not need to be completed, while others should be completed by the user. The operations of FIG. 3 are example operations performed by a patient charting apparatus 102 to assist a user in accessing the correct workflows, and may save a user's time by allowing a user to easily distinguish those workflows that may not need to be completed.

At operation 300, patient charting apparatus 102, may receive, from application server(s) 104 and by communication interface 218, for example, at least one context associated with a session. In this regard, a context may comprise any identifier(s), or the like required by workflow recommendation engine 222 to recommend workflows to application server(s) 104 and ultimately user terminal(s) 110. A context may be based on a variety of information, such as, for example, patient history (such as known medical conditions), a patient visit reason, age, gender, and/or policy. Some example contexts may include “New Patient,” and “Primary Diagnosis,” and some contexts may additionally include a parameter, such as “Age=5.”

A context, or list of contexts, may be generated on an application server, such as, for example, an application server(s) 104, and may be communicated to a patient charting apparatus 102 via a network, such as, for example, network 100. Additionally or alternatively, a list of contexts may be received directly from an application server 104. The patient charting apparatus 102, and more specifically, the workflow recommendation engine 222, may receive a list of contexts via communication interface 218, in a variety of formats. For example, in some embodiments in which the workflow recommendation engine 222 is embodied as a web service, the contexts may be received from a web service client. The request, for example, may be communicated via a protocol such as Simple Object Access Protocol (SOAP), and/or the like. However, it should be appreciated that the contexts may be communicated by any available interface between application server 104 and patient charting apparatus 102.

At operation 310, the workflow recommendation engine 222, under the control of a processor 212, may identify at least one recommended patient charting workflow based on the received context. The workflow may further be identified based on an access control list, status indicator, and/or rule set. The workflow recommendation engine 222 may access the workflow settings of a plurality of workflows, wherein respective workflow settings may comprise some combination of an access control list, status indicator and/or rule or rule set associated with the corresponding workflow. The workflow settings may be stored on memory 214, for example. The workflow recommendation engine 222 may access the workflow settings in order to apply the rule or set of rules of the corresponding workflow to the received context. If the rules of a particular workflow are validated, a context-workflow mapping is created and the workflow is identified as recommended. In a further embodiment, the recommendation engine 222 may also look to the access control list and/or status indicator, also included in the workflow settings, and/or other information stored on memory 214, for example. In some embodiments, the workflow recommendation engine 222 may traverse the plurality of workflow settings, identifying any number of recommended workflows.

It will be appreciated that in addition to identifying recommended workflows, workflow recommendation engine 222 may distinguish different categories of workflows, such as, for example, required workflows. In this regard, a system may require a user to complete a required workflow, while a recommended workflow may not be required. For simplicity, workflows identified by the workflow recommendation engine 222 as described herein are referred to as recommended workflows, regardless of whether the workflow recommendation engine 222 deems a workflow to be recommended, required, or belonging to any other category of workflows.

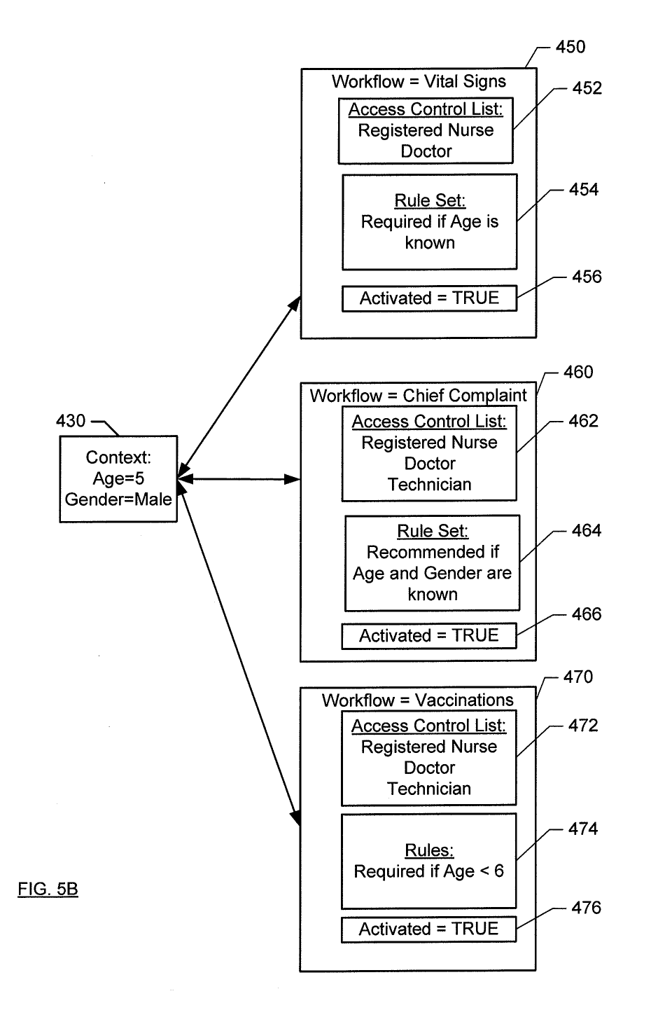

FIG. 5A is a visual representation of example context-workflow mappings for the “New Patient” context 430. A context-workflow mapping such as those illustrated in FIGS. 5A and 5B may be established between a workflow and context when a rule set of the respective workflow is satisfied by the context. A rule set may comprise any number of rules and a rule may be dependent on the context. In this scenario, rule set 444 indicates that workflow 440, “Admission Information,” is mapped to context 430. Rule set 444 indicates that workflow 440 is required when the context is “New Patient,” or null, meaning the context is not known. In other words, the rule set is validated for context 430. Workflow 440, “Admission Information,” is associated with an access control list 442 and status indicator 446. Access control list 442 indicates that given the validation of rule set 444, workflow recommendation engine 222 may identify workflow 440 as a recommended workflow when a user, as identified by logon credentials, for example, is a receptionist, registered nurse and/or doctor. Workflow 440 may not be identified as a recommended workflow in instances the user is a technician, for example. Status indicator 446 may indicate that workflow 440 is active for context 430. A status indicator of false may indicate to workflow recommendation engine 222 that the context-workflow mapping is inactive and the workflow need not be recommended.

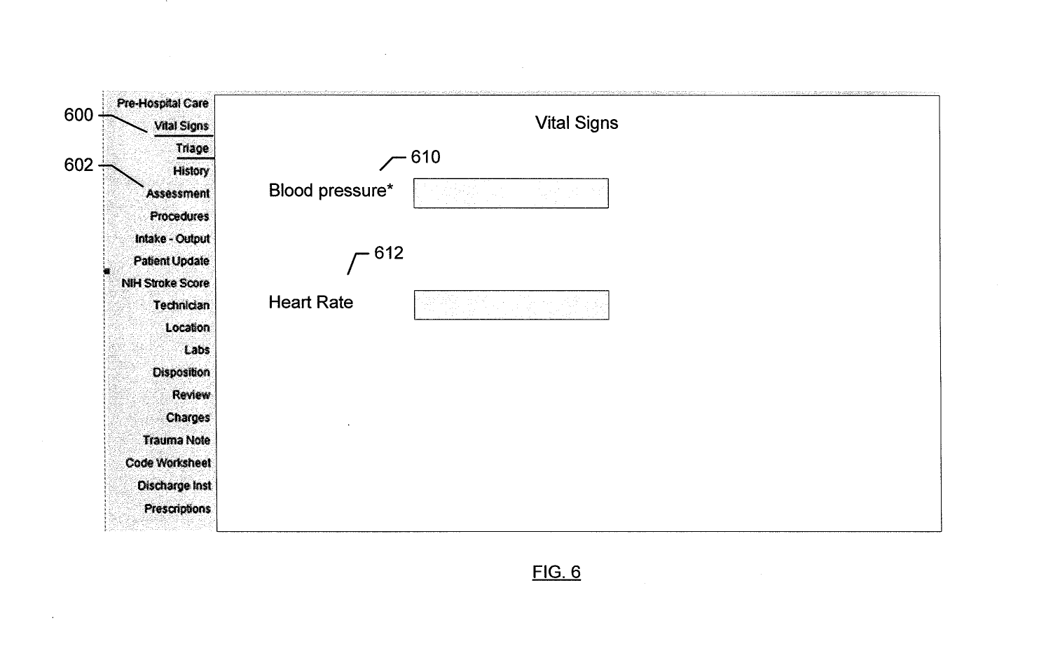

Returning to FIG. 3, upon identifying recommended workflows, workflow recommendation engine 222 may cause the display of the recommended workflows to differ from that of non-recommended workflows, as illustrated by operation 320. A non-recommended workflow may include a workflow that a user may be accustomed to seeing while accessing an application, but based on the context and any other applicable conditions, is not currently recommended. In some embodiments, a non-recommended workflow may optionally be accessed by a user, but may not be required. FIG. 6 illustrates a display according to some example embodiments. Recommended workflow 600 is underlined, indicating a user should complete the workflow. Non-recommended workflow 602 is not underlined, indicating a user may bypass the workflow. Underlining the heading of a recommended workflow is used merely as an example of how to distinguish the recommended workflows from the non-recommended workflows and it will be appreciated that there may be other methods for causing the two types of workflows to be distinguished from each other, such as different coloring, size, and/or shape of any portion of a display. In some example embodiments, workflow recommendation engine 222 may cause the non-recommended workflows to be hidden, or not displayed, while the recommended workflows are displayed. This may be particularly advantageous in mobile systems, such as those used, for example, during in-home patient care, where a user's mobile device may provide limited display space. Additionally or alternatively, in some embodiments, required and recommended workflows may be visually distinguished from one another.

At operation 330, workflow recommendation engine may optionally cause the display of a recommended field within a recommended workflow to differ from that of a non-recommended field. In this regard, context-workflow mappings may further comprise field-level rule sets and/or access control lists in a same or similar manner as described with regard to workflow-level rule sets and/or access control lists. More specifically, workflow recommendation engine 222 may access the fields associated with a workflow in memory 214, and identify those whose entry is recommended. The fields may be visually distinguished, such as illustrated by recommended field 610 and non-recommended field 612 of FIG. 6. In this example, the recommended field 610 is asterisked, and the non-recommended field 612 is not. Workflow recommendation engine 222 may distinguish the fields in any other manner, such as by highlighting, and/or varying the placement of fields on the display. In some embodiments, non-recommended fields may be hidden from view. Any indication to distinguish workflows may be communicated to application server(s) 104 and or user terminal(s) 110, for example, via communication interface 218. Additionally or alternatively, workflows may be displayed directly on user interface 216 of patient charting apparatus 102.

Continuing to operation 340, workflow recommendation engine may optionally update recommended workflows dynamically during a patient charting session. The recommended workflows may be updated based on a changed context. As such, workflow recommendation engine 222 may detect a change in context and re-analyze context-workflow mappings, and subsequently update the recommended workflows. In one embodiment, the recommended workflows may update based on completion of at least one workflow. In this regard, workflow recommendation engine 222 may detect completion of a workflow, either by user indication and/or navigation away from a workflow, for example, and re-analyze context-workflow mappings to see if there may be any changes to the recommended workflows. For example, a user may update a field in one workflow that impacts a rule of another context-workflow mapping. Therefore, upon completion of a workflow, in such a scenario, a display may be updated to reflect the update in recommended workflows.

FIG. 5B is a visual representation of how the context-workflow mappings of FIG. 5A may change following completion of the Admission Information workflow 440. After receiving additional information in the workflow 440, workflow recommendation engine 222, may receive indication of updated context 440, such as “age=5” and “gender=male.” The updated contexts may cause the context-workflow mappings and thus, the recommended workflows to change. For example, rule set 454 of workflow 450 may be validated because context 440 includes age. As shown in rule set 454, workflow 454 may be required for context 440. Rule set 464 of workflow 460 may be validated because context 440 includes age and gender. According to rule set 454, workflow 460 may be recommended for context 440. Rule set 474 of workflow 470 may be required because context 440 indicates that age is less than 6. The workflows' respective access control lists 452, 462, and 472, status indicators 456, 466, and 476 provide additional information to workflow recommendation engine 222 to determine what workflows, if any, will be recommended to a user.

FIG. 4 is a flowchart illustrating administration of the workflow settings, such as access control lists, status indicators, and rule sets. Patient charting administrator 220 may provide authorized users with administration capabilities. At operation 400, patient charting administrator 220 may provide functionality allowing a user to administer the status indicator of a workflow, such as activating or deactivating a workflow. Operation 410 provides for administration of access control lists. In this regard, an authorized user may add and/or remove user roles from an access control list. In addition to a user role, an individual user identification and/or identifier associated with a specialized group such as a lab or radiology unit may be added to an access control list. Operation 420 provides for administration of rule sets. Authorized users may add or remove rules, or edit rules such as by modifying the parameters. Any updates made to the workflow settings in accordance with operations 400-420 may be communicated from user terminal(s) 110 via communication interface 218, and may cause the patient charting administrator 220 to update the workflow settings stored on memory 214.

FIGS. 3 and 4 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a patient charting apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a patient charting apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for patient charting comprising:
receiving at least one context associated with a patient charting session;
identifying, with processing circuitry, at least one recommended workflow based on the at least one context; and
causing display of the at least one recommended workflow, such that the display of the at least one recommended workflow differs from a display of a non-recommended workflow.

2. A method according to claim 1, wherein the at least one context is based on at least one of:
patient history;
patient visit reason;
age;
gender; or
policy.

3. A method according to claim 1, further comprising:
dynamically updating the at least one recommended workflow during the patient charting session.

4. A method according to claim 3, wherein dynamically updating further comprises:
updating the at least one recommended workflow based on completion of at least one workflow.

5. A method according to claim 1, wherein identifying at least one recommended workflow further comprises identifying the at least one recommended workflow based on an access control list.

6. A method according to claim 1, wherein identifying at least one recommended workflow further comprises identifying the at least one recommended workflow based on a rule set.

7. A method according to claim 1, wherein causing display of the at least one recommended workflow comprises causing the at least one recommended workflow to be displayed and the non-recommended workflow to not be displayed.

8. A method according to claim 1, wherein the at least one recommended workflow comprises a plurality of fields, and the method further comprises identifying at least one recommended field of the plurality of fields.

9. A method according to claim 1, further comprising:
causing display of at least one recommended field to differ from that of a non-recommended field.

10. A method according to claim 1, further comprising providing administration of at least one of:
a status indicator associated with a workflow;
an access control list associated with a workflow; or
a rule set associated with a workflow.

11. An apparatus for patient charting comprising processing circuitry configured to cause the apparatus to at least:
receive at least one context associated with a patient charting session;
identify at least one recommended workflow; and
cause display of the at least one recommended workflow, such that the display of the at least one recommended workflow differs from a display of a non-recommended workflow.

12. An apparatus according to claim 11, wherein the processing circuitry is further configured to cause the apparatus to at least:
dynamically update the at least one recommended workflow during the patient charting session.

13. An apparatus according to claim 12, wherein dynamically updating further comprises:
updating the at least one recommended workflow based on completion of at least one workflow.

14. An apparatus according to claim 11, wherein identifying at least one recommended workflow further comprises identifying the at least one recommended workflow based on an access control list.

15. An apparatus according to claim 11, wherein identifying at least one recommended workflow further comprises identifying the at least one recommended workflow based on a rule set.

16. An apparatus according to claim 11, wherein causing display of the at least one recommended workflow comprises causing the at least one recommend workflow to display and the non-recommended workflows to not display.

17. An apparatus according to claim 11, wherein the processing circuitry is further configured to cause the apparatus to at least provide administration of at least one of:
a status indicator associated with a workflow;
an access control list associated with a workflow; and
a rule set associated with a workflow.

18. A computer program product for patient charting comprising at least one non-transitory computer-readable medium having computer-readable program instructions stored therein, the computer-readable program instructions comprising instructions, which when performed by an apparatus, are configured to cause the apparatus to at least:
receive at least one context associated with a patient charting session;
identify at least one recommended workflow; and
cause display of the at least one recommended workflow, such that the display of the at least one recommended workflow differs from the display of a non-recommended workflow.

19. A computer program product according to claim 18, wherein the instructions are further configured to cause the apparatus to at least:
dynamically update the at least one recommended workflow during the patient charting session.

20. A computer program product according to claim 19, wherein dynamically updating further comprises:
updating the at least one recommended workflow based on completion of at least one workflow.

21. A computer program product according to claim 18, wherein identifying at least one recommended workflow further comprises identifying the at least one recommended workflow based on an access control list.

22. A computer program product according to claim 18, wherein identifying at least one recommended workflow further comprises identifying the at least one recommended workflow based on a rule set.

23. A computer program product according to claim 18, wherein causing display of the at least one recommended workflow comprises causing the at least one recommend workflow to display and the non-recommended workflows to not display.

24. A computer program product according to claim 18, wherein the instructions are further configured to cause the apparatus to at least provide administration of at least one of:
a status indicator associated with a workflow;
an access control list associated with a workflow; and
a rule set associated with a workflow.
